(19) United States
(12) Patent Application Publication
(10) Pub. No.: US 2006/0025880 A1
(43) Pub. Date: Feb. 2, 2006

(54) HOST CONTROL FOR A VARIETY OF TOOLS IN SEMICONDUCTOR FABS

(75) Inventors: Padmavathi D. Chukka, Poughkeepsie, NY (US); Ying Du, Sterling, VA (US); Barry M. Herbold II, Beacon, NY (US); Benjamin W. Herta, Poughquag, NY (US); Krithikpriya R. Kunka, Poughquag, NY (US); Frank T. Liang, Poughkeepsie, NY (US); Robert J. MacHugh, Newburgh, NY (US); Sorabh Murgai, Wappingers Falls, NY (US); Thomas T. O'Leary, Hyde Park, NY (US); Chinmay S. Oza, Danbury, CT (US); Rakesh K. Parimi, Beacon, NY (US); Martin J. Soyka, Wappingers Falls, NY (US)

Correspondence Address: INTERNATIONAL BUSINESS MACHINES CORPORATION;DEPT. 18G, BLDG. 300-482, 2070 ROUTE 52, HOPEWELL JUNCTION, NY, 12533, US

(73) Assignee: International Business Machines Corporation, Armonk, NY (US)

(21) Appl. No.: 10/710,709

(22) Filed: Jul. 29, 2004

(51) Int. Cl. G06F 19/00

(52) U.S. Cl. 700/121; 700/96

(57) ABSTRACT

A software module for use within an integrated circuit fabrication facility sends commands to a tool according to a method that operates with any tool that satisfies SEMI standards to add or subtract steps in a process without reprogramming or recompiling. The program operates autonomously to change parameters of commands that it sends to the tool to improve performance of the fab.

### BACKGROUND OF INVENTION

1. Technical Field

The field of the invention is that of integrated circuit fabrication, in particular controlling the operation of a variety of processing tools in a fabrication facility (fab).

2. Background of the Invention

In modern integrated circuit processing technology, there are several kinds of equipment in a fab, typically produced by different manufacturers.

The basic processes of forming an integrated circuit include depositing a layer of material on a substrate, defining a pattern in a layer of photoresist and etching the pattern that was defined to transfer the pattern to the layer. Those skilled in the art are aware of positive and negative patterns, implantation, and other processes.

The machines that perform the individual processing steps are computer controlled and perform their function in response to stored parameters. For example, a chemical vapor deposition tool will have stored values for the flow rates of the gases that combine to form the film being deposited, for the temperature of the wafer during deposition (or for the power applied to the heating lamps), for the vacuum, for the time duration of the process, etc.

These parameters may change during the processing cycle; e.g. one or more parameters may start with an initial value and change that value during the course of the process. There may be many variations of a single process that are used with different products. In a foundry or other multi-part environment, there may be technical reasons to vary the thickness of a film or the directionality of an etch, or it may simply be a difference in preference between one chip designer and another.

Currently, a software program, referred to as Host Control Software (HCS), sends commands to the tool or tools to run the process. The HCS may be part of a larger software system that controls the flow of wafers through the fab and changes the recipe of an individual tool when a batch of wafers requires a different recipe.

The use of the same HCS program for a chemical vapor deposition tool and an etching tool, say, will require reprogramming the code in the control software to account for the different functions performed by the tool and the different internal control software in the tool.

No known HCS can connect to different 300 mm tool types without requiring code changes in the original software. Further, current HCS programs do not allow runtime behavior modification without disrupting communications between the tool and the manufacturing execution system or the processing of the product.

In addition, current HCS does not provide a mechanism to perform performance diagnostics on semi compliant equipment and equipment control systems to run diagnostic tests to improve the performance of the ecs and other systems.

The art could benefit from an integrated control system that controls different tool types without reprogramming, including varying the parameters of a particular process to improve the performance of the system.

### SUMMARY OF INVENTION

The invention relates to HCS that allows development, deployment, testing, maintenance and upgrade of semiconductor host control software for different types of tools made by different vendors without the need to develop, compile and maintain new programs for new tool types.

A feature of the invention is that the program is written generally and flexibly, so that it can control any type of tool that complies with SEMI standards.

A feature of the invention is that a tool is initially configured by entering data representing the desired result in a standard form, in response to which the HCS generates the required control signals to the tool to produce that result.

Another feature of the invention is that the HCS generates tests to perform integration testing of the tool without further input.

Another feature of the invention is that a process of tool control is divided into units of work (workitems) that can be enabled, disabled or added to without reprogramming or recompiling the software.

### BRIEF DESCRIPTION OF DRAWINGS

FIG. 1 illustrates an overall view of the process of controlling a fab, showing the relationship of the inventive software to other software.

FIG. 2 illustrates the process of setting up a new tool.

FIG. 3 illustrates an example of controlling a tool.

FIG. 4 shows the relationship between the HCS, the diagnostic system employed by the HCS and the tool and tool control system.

FIG. 5 illustrates the operation of the diagnostic system.

### DETAILED DESCRIPTION

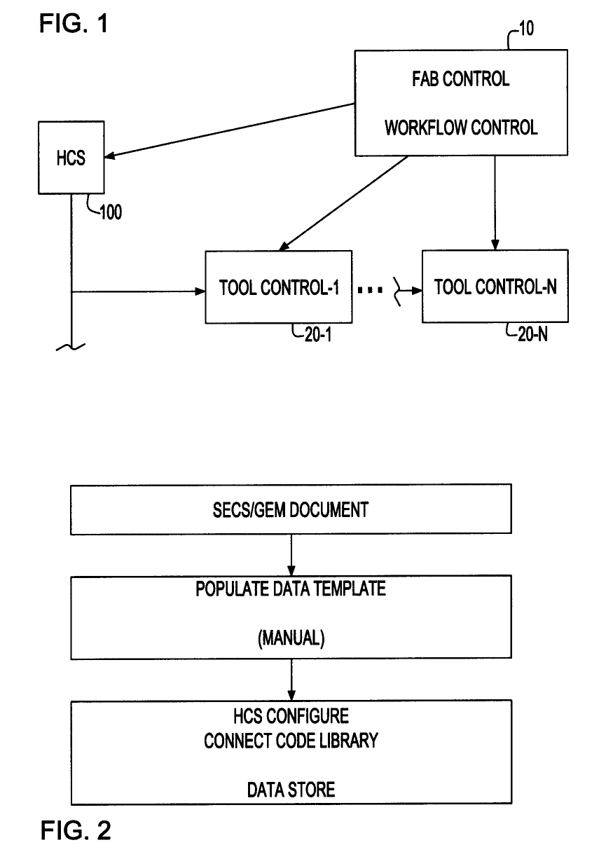

FIG. 1 illustrates an example of a fab control system employing the invention, in which block 10 represents an overall system, referred to as a manufacturing execution system or MES, that is aware of the status of all wafers in the fab and directs them to the sequential steps in the process.

On the lower right of the Figure, boxes 20-1-20-n represent individual tools. Box 100, on the lower left, represents a program according to the invention, referred to as a host control system or HCS, that receives commands from the master system and passes commands on to the individual (one or more) tools. The commands may simply be passed through, or they may be a relatively high level command that results in a number of lower level commands to the tool. In addition, the HCS will monitor the tool or tools and adjust communication in order to improve fab performance.

In the past, differences in tool types required that the control software (either the global control on an intermediate level) be recompiled when there was a change in the workflow or when there was a new tool added. For example, when a new step was added to a recipe of a workflow, that code section would be rewritten, recompiled and inserted in the HCS software.

According to the invention, the addition of a new tool or a change to the workitems and/or sequence of items can be accommodated without restarting or recompiling the HCS.

FIG. 2 illustrates the setup sequence in which data from a SECS/GEM document is entered into a software template and is then transferred without further human intervention to the HCS, which places it in a database, which may be local to a particular tool or fab-wide. Examples of the data to be entered are—a change in the sequence of a workitem or a new workitem, the SECS-GEM format for a report ID, the SECS-FORMAT for DataID, the tool type (Process on Measurement), the Event ID for Carrier Placed, the Carrier ID Verified, etc. Parameters other than SECS/GEM may also be used.

In the case of a change in sequence, the operator may, e.g. either: a) examine a list of workitems in a workflow and press up or down arrow keys to change the order; or b) edit a sequence number that gives the sequence of workitems. In the case of enabling or disabling a workitem, the operator may change a flag accordingly. Other techniques for permitting the software engineer to make a change will be evident to those skilled in the art.

Adding a new workitem may be accomplished by typing in the item (selected from the repertory of the particular tool that is set by the tool manufacturer) using the format for a java class, well known to those skilled in the art. The HCS program then sends that command as it processes the java classes within the workflow.

It is an advantageous feature of the invention that the steps in the sequence of operations executed by a particular tool may be altered without recompiling the HCS, since the HCS takes advantage of a feature of the java language that picks up and processes or executes items that are java classes without the need to recompile.

Another advantageous feature of the invention is that the HCS deals with all the tools in the same way. The workitems for an etching tool may differ from those used in a deposition tool, but the HCS operates according to a standard flow, differing in the detailed steps within the flow.

When a carrier containing a lot of wafers to be processed arrives at a tool, the HCS will send a reservation command to the tool that specifies the carrier and the carrier ID, together with a slot map. The tool will check the carrier ID to be sure that the correct carrier has arrived. The HCS will send commands to the tool to process the wafers—e.g. execute the k^{th} recipe on the wafer in the m^{th} slot, etc until all the wafers are processed.

The HCS will check that the correct recipes are stored within the tool. If a particular recipe is not stored within the tool, the tool will notify the HCS and the HCS will download the recipe from the overall system and send it to the tool.

The HCS will create “jobs” that include a list of wafers in the carrier that receive the same recipe, referred to as a process job. A collection of process jobs will be referred to as a control job; e.g. process job #7, then process job #3, etc.

The HCS performs error recovery, as required, in which the HCS responds to an error signal from the tool by commanding it to stop all processing on wafers from this carrier and unload the carrier. The HCS collects relevant data from the tool as to which wafers were successfully processed before the error, which were not yet processed and which had the recipe that was being run when the error occurred and the particular wafer that was being processed at the time of the error.

This information is available to process engineers who can send on wafers that were successfully processed, process (perhaps in another tool) wafers that were not yet processed and deal with the wafers that had the problem.

The HCS assembles data from tests performed by the tool and passes the results to the data store where they are available to the overall fab MES and to other programs to monitor progress of a particular lot and to collect statistics on the performance of the fab.

The HCS has access to a database with data from sources other than the particular tools that it controls, e.g. measurement tools that may be physically separate from the processing tools.

The tool can then proceed with another carrier (assuming that the error permits using another recipe and does not render the tool inoperative).

The HCS will monitor the tool for error signals and alarms, ignoring some signals that are below a threshold of significance and responding to signals that are important.

The HCS checks that data have been collected by the tool on the wafers it has processed and passes the data to the proper location.

The HCS checks that all the wafers in the carrier have been processed.

The HCS looks for the next job in sequence and loops around to repeat the process.

Information Gathering

The HCS is constantly gathering information from the tool. The information gathered by the HCS is determined by a configurable set of rules stored in the HCS that are used to define reports on the Tool. These reports can also be changed on the fly without recompiling or linking. The tool thereafter sends periodic reports to the HCS containing the requested data. The HCS reads all reports sent by the Tool and responds by sending adjustment commands (with parameter value updates in some cases) to the Tool. The Tool then reads the parameter updates and updates its data library. This process permits the HCS to help to do automatic diagnostics on the Tool and monitor and/or improve Tool performance.

According to the invention, the flow of the invention is divided into units called “workitems” that are arranged in sequential workflows. Workitems can be added, disabled or removed at runtime or any time without recompiling the software.

Only enabled items are executed by the HCS and sent to the tool at runtime.

A Workflow may be initiated in response to an impetus from the tool or from other equipment in the fab (e.g. the material transport system, the fab controller, etc.).

An advantageous feature of the invention is that the HCS system may be programmed with knowledge about the different parameters that affect the performance of the parent system.

The module has internal logic to manipulate the parameters to better the performance of the parent (fab-wide) system.

In the case of a deposition tool, the HCS runs a batch of wafers, performs the diagnostic routine in FIG. 5 that, in this case looks at parameters P1, P2,—of the tool operation. The HCS has control over operating parameters k1, k2 of the tool and adjusts them, monitoring the result, and evaluating the result of each change on the overall system performance according to an algorithm stored internally. As a simple example, the HCS sends parameters to the tool for gas flow and RF power and receives measurements of film thickness. The algorithm is restricted so the HCS is not free to change all parameters or to extend the range of a parameter beyond limits that are set in advance; e.g. if it is known that a certain RF power will increase the speed of deposition but will produce a film of unacceptable quality, the permitted range of that parameter will be limited. The HCS suggest a new set of operating parameters to the overall system control that may be accepted, rejected or modified. The new set of (perhaps modified) parameters is then put into the standard procedure for that type of wafer.

Another feature of the invention is that the HCS helps to do diagnostics on the HCS itself. The HCS has a mechanism of publishing its performance information to an external process program, say the HCS Diagnostics Application.

These diagnostics are conducted by an external process program that dynamically captures data fields/items from the Equipment/Tool into HCS Diagnostics via the HCS and manipulates the collected data fields/items for improving process on the Equipment/Tool and/or performance of the HCS.

The HCS Diagnostics Application contains a set of configurable rules that are used to define what type of information the Diagnostics Application is interested in gathering from the HCS. This information is sent to the HCS and registered within the HCS.

The HCS Diagnostics application is dynamically configurable such that the HCS Diagnostics is a plug-in available for each Tool/Equipment. The HCS Diagnostics when installed as a plug-in automatically determines the type of Equipment (CMP, Furnace, RIE, ETCH, LITHO, etc.) being controlled by the HCS. The Equipment type being controlled by the HCS is a parameter of the HCS itself. Thereafter, the HCS Diagnostics will auto-reconfigure itself with the latest executable library and be ready for use.

The HCS thereafter periodically sends the performance related information (defined in the previous step) to the HCS Diagnostics Application. This information is sent between these two applications (HCS and HCS Diagnostics) via any standardized communication application protocol.

The HCS diagnostics receives information published by one or more HCS. It processes the information using the set of rules defined to identify “tuning parameter” adjustments, on the interaction between the HCS and the tool, such as frequency of performing a hand-shake between the HCS and Tool, frequency of HCS performing database read cache updates from HCS Database, frequency of HCS performing a job state (e.g. Control Job State) check on Tool.

The HCS Diagnostics routine determines how to adjust these parameters from the diagnostics information published by the HCS and thereafter sends one/more parameter updates to the HCS. The HCS reads the adjustment commands and thereafter reacts by adjusting its own process with/without adjusting Tool behavior if required.

The logistics/software engineer can enhance the list of Equipment types above and provide an enhanced executable library to perform diagnostics on Equipment types not supported by the default HCS Diagnostics.

Advantageously, the HCS module uses existing SEMI protocols for communicating with the fab control system.

Further, the module operates autonomously to vary and adjust the parameters under its control to reach an improved result.

Yet further, the module reads metric values as described above from the system and after evaluation of the effect of the present values suggests new metric values to the system.

The HCS Diagnostics can record default performance metrics about the HCS such as “memory usage, average message response time to Equipment/Tool, average hand-shake time with the Equipment/Tool, average Equipment/Tool message time-out, database cache size”, these and other similar parameters being collectively referred to as HCS-Tool Interface, and will manipulate the data for determining adjustments that need to be made to the HCS for better performance.

In operation, the diagnostic system illustrated in FIG. 5 is designed such that it can be programmed with knowledge about the different parameters that affect performance of the parent system and will adjust parameters as permitted by the algorithm.

The HCS Diagnostics records certain data fields/items that are reported by the Tool/Equipment to the HCS. Such data fields/items are custom defined for a particular HCS/Equipment instance. For example, for a CMP Polish Equipment we might be interested in gathering data fields/items such as polish time or wafer thickness for the polished wafer. For Equipment such as a Furnace Tool we might be interested in gathering information such as furnace temperature, air pressure, etc.

The HCS Diagnostics algorithm is independent of the Tool types (CMP, Furnace, etc.) it is applied to. The HCS Diagnostics is a plug-in module to an HCS. This means that the HCS Diagnostics is optional for the HCS. The HCS Diagnostics can be enabled/disabled remotely within the HCS per user request using standard application programming interface techniques.

Provided that the HCS Diagnostics is enabled for the HCS, the HCS Diagnostics will then record information as described above. Provided the HCS Diagnostics is enabled for the HCS, the HCS Diagnostics will then respond to the collected/gathered data fields/items according to the logic programmed within the HCS Diagnostics.

An example is that of Simple Response Logic for CMP Tools:

The HCS Diagnostics will respond to wafer thickness by adjusting the polish time to ensure that the wafer is not over/under polished.

The logic for all tools is not described here, but a simple logic can be applied for each tool type per the process (CMP, Furnace, RIE, ETCH, LITHO, etc.) for corresponding tool types.

Additionally the HCS Diagnostics can also record data fields/items about the HCS and perform diagnostics on the collected data fields and send feedback to the HCS. This feature requires the HCS to be able to communicate two-way with the HCS Diagnostics.

Data fields/items pertaining to HCS's performance, includes: memory usage, average message response time to Equipment/Tool, average hand-shake time with the Equipment/Tool, average Equipment/Tool message time-out, etc.

The HCS Diagnostics applies logic programmed by a logistics/software engineer person—so that the HCS Diagnostics can sense that the HCS parameters need to be adjusted or “fine-tuned” in order to maintain effective and reliable communications between the HCS and Equipment/Tool.

The HCS Diagnostic does not necessarily have to “run” as an “application module” on the server hosting the HCS. The HCS Diagnostics can “run” and “execute” on any server that provides a reliable network communication path to the HCS.

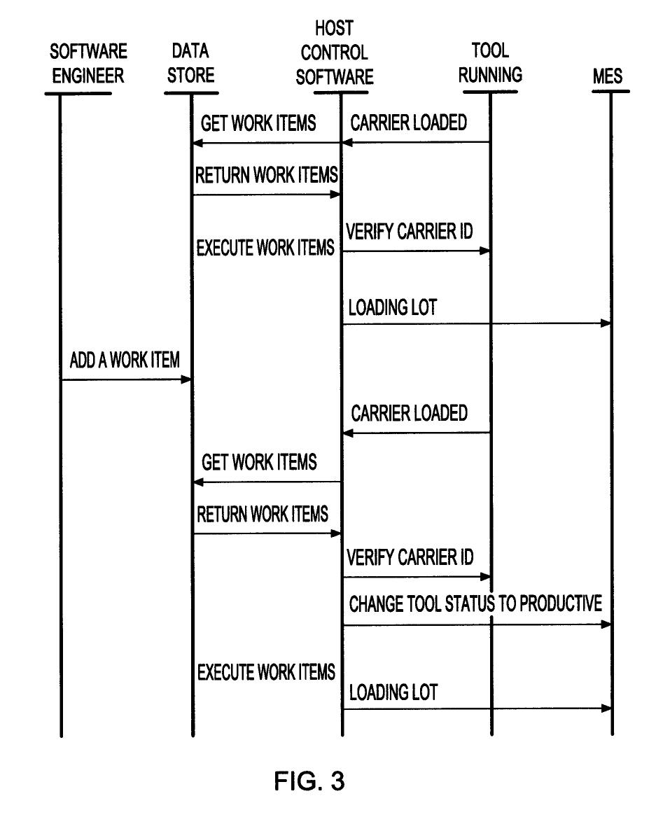

FIG. 3 shows a diagram representing an example of controlling and altering a workflow by means of the invention. Five vertical lines represent sources and destinations of data and commands. At the top center of the Figure, the tool sends a signal to the HCS that a carrier has been loaded. The HCS responds by fetching the next workitems to be done from the database (if it has not already done so).

Next, the carrier ID is verified, checking that this carrier is in fact the one scheduled by the overall fab control system to be processed by this tool.

The process recipe specified by the fab control system is then executed. The lot of wafers is then loaded from the tool into the material transport system.

On the left a line extending downward from the software engineer represents the addition of a new workitem that can be added to the steps that are stored without recompiling the HCS software.

This beneficial result is accomplished by the use of java classes for workitems, so that the feature of the java system of adding (and subtracting) classes without recompiling permits changing the workflow Aon “the fly”.

In the next section, the previous steps are repeated with the new wafers in the next carrier.

An optional feature of the invention is that a diagnostic system may be included in the HCS. This may be applied to any HCS used in a plant that conforms to the semi standards.

This ability to perform diagnostics regardless of the limitations of the tool manufacturer's software permits the fab to be organized more systematically.

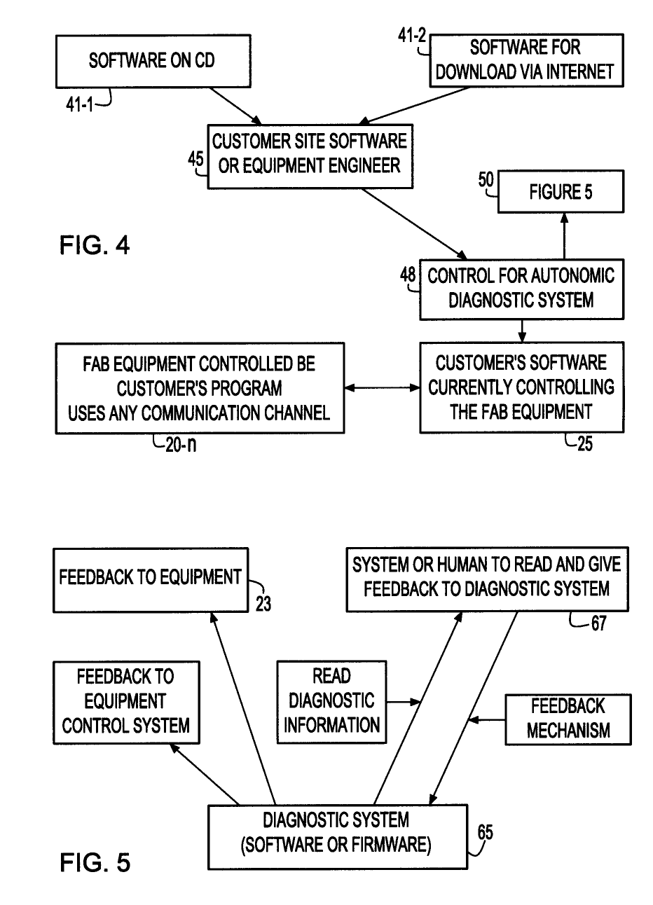

FIG. 4 illustrates the flow of a process of receiving an HCS (or an update) and applying it to a tool or tools.

At the top of the Figure, boxes 41-1 and 41-2 indicate methods of receiving the control software. Box 45 represents the receiving entity, either a software engineer who will perform the installation manually or a fab control system that will automatically take the same steps.

In the lower right, box 48 represents the storage of the control software, which may be on a server that is controlling a number of tools or in a firmware solid state storage.

Boxes 25 and 20-n represent the tool manufacturer's control software (or the fab operator's software) that controls the tool and the nth tool itself.

Box 50 represents the diagnostic software that performs diagnoses and corrections on the tool control software and on the HCS itself. The diagnostic system is general and, complying with SEMI standards, may be used with HCS system other than the preferred embodiment discussed herein; i.e. with systems from other providers.

FIG. 5 illustrates the operation of a diagnostic system according to the invention, in which box 55 at the lower center represents the software, line 58 represents transmission of diagnostic information collected by the tool or by ancillary detectors to the analyzing portion of the system, which preferably is an optimizing routine in software, but may be supplemented by a human engineer.

Changes to parameters controlled by the HCS are returned along line 59. The changes are then fed back to the equipment directly (e.g. a change in gas flow rate) in box 23 or to an equipment control system box 27, if the particular equipment does not have provision for direct communication and can only communicate through a control system.

The diagnostic system is flexible and can be tuned to extract data from internal source within the tool and/or from external sensors (or human inputs).

The invention may be implemented in software or firmware and may reside on a server, as an attachment to the tool that it controls or in any other convenient location. The physical embodiment of the inventive program may be in an article of manufacture, e.g. firmware, a floppy disk, a hard disk, CD, tape or any other storage medium.

While the invention has been described in terms of a single preferred embodiment, those skilled in the art will recognize that the invention can be practiced in various versions within the spirit and scope of the following claims.

What is claimed is:

1. An article of manufacture in computer readable form comprising means for performing a method for operating a computer system having a host control program (HCS) for controlling at least one tool in a semiconductor fabrication facility, said method comprising the steps of:
sending commands to at least one fabrication tool of any compliant tool type that complies with a standard protocol to perform a process in an integrated circuit manufacturing sequence performed on a wafer of integrated circuits, said commands comprising a workflow of workitems; in which each of said workitems has a status flag associated therewith said flag being one of a set of categories including at least enable and disable; and
each of said workitems is in the form of a java class, whereby individual ones of said workitems may be enabled or disabled and new workitems may be added to operate on a tool made by any manufacturer that complies with said standard without recompiling or restarting said HCS.

2. An article of manufacture according to claim 1, further comprising a step of changing a sequence of workitems in a workflow without recompiling said HCS.

3. An article of manufacture according to claim 1, in which said HCS contains a configurable set of rules that control the gathering of information by said HCS from said tool, further comprising a step of changing a configuration of said set of rules without recompiling said HCS.

4. An article of manufacture according to claim 1, in which said method further comprises a setup step for a particular tool, in which data are entered in a template and are automatically converted to workitems in the correct format by said HCS, without further human intervention.

5. An article of manufacture according to claim 1, in which said method further comprises at least one variation step in which:
said HCS alters at least one command sent to said tool, thereby making changes in one or more parameters of said command;
said HCS then evaluates the result of said changes and retains changes that improve the performance of said tool.

6. An article of manufacture according to claim 5, in which said at least one variation step is under the control of at least one of a configurable set of rules that control the gathering of information by said HCS from said tool, whereby the range over which said HCS may vary a parameter is controlled by said set of configurable rules.

7. An article of manufacture according to claim 5, in which said at least one variation step changes a member of a HCS-Tool Interface.

8. An article of manufacture according to claim 3, in which said method further comprises at least one variation step in which said HCS alters at least one command sent to said tool, thereby making changes in one or more parameters of said command; said HCS then evaluates the result of said changes and retains changes that improve the performance of said tool.

9. An article of manufacture according to claim 8, in which said at least one variation step is under the control of said configurable set of rules that control the gathering of information by said HCS from said tool, whereby the range over which said HCS may vary a parameter is controlled by said set of configurable rules.

10. An article of manufacture according to claim 9, in which said at least one variation step changes a member of a HCS-Tool Interface.

11. An article of manufacture according to claim 1, further comprising a diagnostic module in communication with said HCS, in which said diagnostic program receives data from said HCS, evaluates said data and generates at least one modified parameter of said method.

12. An article of manufacture according to claim 11, in which said diagnostic program receives data from at least two HCS controlling tools that sequentially process wafers according to a recipe.

13. An article of manufacture according to claim 11, in which said diagnostic program receives data comprising members of said set of HCS-Tool Interface from at least one HCS.

14. An article of manufacture according to claim 11, in which said diagnostic program receives data from at least one HCS representing the result of a process applied by a tool controlled by that HCS.

15. An article of manufacture according to claim 11, in which said method further comprises at least one variation step in which:
said diagnostic program alters at least one command sent to said HCS, thereby making changes in one or more parameters of said command;
said diagnostic program then evaluates the result of said changes and retains changes that improve the performance of said tool.

16. An article of manufacture according to claim 11, in which said at least one variation step is under the control of at least one of a configurable set of rules that control the adjustment of parameters of commands from said HCS to said tool, whereby the range over which said HCS may vary a parameter is controlled by said set of configurable rules.

17. An article of manufacture according to claim 11, in which said at least one variation step changes a member of a HCS-Tool Interface.

18. A system for processing an integrated circuit wafer in at least one tool in a semiconductor fabrication facility, comprising:
at least one fabrication tool of any compliant tool type that complies with a standard protocol to perform a process in an integrated circuit manufacturing sequence performed on a wafer of integrated circuits;
a data processing unit in communication with said fabrication tool and having a HCS for controlling said tool: sending commands to said tool comprising a workflow of workitems; in which each of said workitems has a status flag associated therewith said flag being one of a set of categories including at least enable and disable; and
each of said workitems is in the form of a java class, whereby individual ones of said workitems may be enabled or disabled and new workitems may be added to operate on a tool made by any manufacturer that complies with said standard without recompiling or restarting said HCS.

19. A system according to claim 18, in which said commands to said tool further comprises at least one variation step in which:
said HCS alters at least one command sent to said tool, thereby making changes in one or more parameters of said command;
said HCS then evaluates the result of said changes and retains changes that improve the performance of said tool.

20. A system according to claim 18, in which said at least one variation step is under the control of said configurable set of rules that control the gathering of information by said HCS from said tool; and
said one or more parameters are members of a HCS-Tool Interface.
